(19) United States
(12) Patent Application Publication
(10) Pub. No.: US 2025/0265662 A1
(43) Pub. Date: Aug. 21, 2025

(54) ANGLED DRIVE-THROUGH DELIVERY SYSTEM AND METHOD

(71) Applicant: John Yackley, Lakehead, CA (US)

(72) Inventor: John Yackley, Lakehead, CA (US)

(21) Appl. No.: 18/768,404

(22) Filed: Jul. 10, 2024

Related U.S. Application Data
(60) Provisional application No. 63/555,785, filed on Feb. 20, 2024.

(51) Int. Cl. G06Q 50/12; G06Q 10/0836; G06Q 20/18

(52) U.S. Cl. CPC G06Q 50/12; G06Q 10/0836; G06Q 20/18

(57) ABSTRACT

An electronic drive-through delivery system is configured to receive and process customer restaurant orders from vehicles includes an electronic ordering system and a lane system. The electronic ordering system has a plurality of electronic kiosks each having a screen, a processing unit running a client-side application configured to visually output an interface onto the screen of its kiosk, and a central server communicatively connected to the plurality of electronic kiosks. The server runs a server-side order-processing application configured to receive customer orders placed via the kiosk interface. The lane system is configured to minimize a backup queue of customers and eliminate a bottleneck of exiting customers, and includes a plurality of angled drive-through slots at which the plurality of electronic kiosks are positioned, an entrance lane, and an egress lane accessible from the entrance lane via the angled drive-through slots that are angled relative to the entrance and egress lanes.

### RELATED U.S. APPLICATION DATA

This application claims priority to, and is a continuation-in-part of, Non-Provisional Application No. 63/555,785, filed on Feb. 20, 2024.

### FIELD OF THE INVENTION

This disclosure relates to the field of electronic ordering and delivery systems operating on land parcels, particularly those systems utilized in restaurant drive-throughs or drive-ins.

### BACKGROUND

Restaurant drive-throughs, while convenient for customers looking to grab a quick meal, often face challenges related to service speed. During peak hours, the demand can exceed the processing capacity of the restaurant, leading to slower service. This slowdown is exacerbated by complex orders or payment issues, which can cause frustration among customers waiting in line. The expectation of fast service is a core aspect of the drive-through experience, and any delay can negatively impact customer satisfaction and the establishment's reputation for efficiency.

Traffic congestion is another significant issue for drive-throughs. The design of the entry and exit points can sometimes be inadequate to handle the high volume of vehicles, especially during meal times. This can lead to cars spilling onto the main road, causing disruptions in the flow of traffic. The situation is worsened when multiple drive-throughs are located in close proximity, creating a compounded effect on the surrounding traffic infrastructure. The resulting congestion not only affects the drive-through customers but also other road users who may be delayed or inconvenienced.

Safety concerns are also paramount in drive-through operations. The mix of moving vehicles and pedestrians in a confined space increases the risk of accidents. Backup queues can lead to impatience, with drivers sometimes engaging in risky maneuvers to bypass the line or exit the queue. Additionally, the close quarters of drive-through lanes can lead to fender benders or more serious collisions if drivers are not paying close attention to their surroundings, or have obscured views of some drivable areas. Ensuring the safety of both customers and staff is a critical challenge that drive-through restaurants must address.

Conventional drive-through organization and ordering systems typically involve one-at-a time ordering and delivery. Consequently, customers are left waiting in a queue behind the window, slowing down ordering and delivery. This is a problem, no matter how much onsite or available land can be acquired for an establishment. Therefore, there is a need in the art for new drive-through designs and methods which optimize convenience and traffic flow.

### SUMMARY

In one embodiment, an electronic drive-through delivery system is configured to receive and process customer restaurant orders from vehicles includes an electronic ordering system and a lane system. The electronic ordering system has a plurality of electronic kiosks each having a screen, a processing unit running a client-side application configured to visually output an interface onto the screen of its kiosk, and a central server communicatively connected to the plurality of electronic kiosks. The server runs a server-side order-processing application configured to receive customer orders placed via the kiosk interface. The lane system is configured to minimize a backup queue of customers and eliminate a bottleneck of exiting customers, and includes a plurality of angled drive-through slots at which the plurality of electronic kiosks are positioned, an entrance lane, and an egress lane accessible from the entrance lane via the angled drive-through slots that are angled relative to the entrance and egress lanes. In one aspect, the entrance and egress lanes run substantially parallel to each other, the angled drive-through slots being positioned between the entrance and egress lanes. In another aspect, the lane system includes only one-way lanes. In yet another aspect, the at least three customers can order and pay simultaneously. In a further aspect, the angled drive-through slots are covered by a canopy structure. In another aspect, the electronic drive-through delivery is located on a land parcel that includes a plurality of standard parking spaces positioned adjacent to the entrance lane, the entrance lane positioned between the angled drive-through slots and the standard parking spaces. In another aspect, the vehicle transitions from the entrance lane to an angled drive-through slot via a first obtusely angled turn, the customer having a line-of-sight to the entire egress lane when pulling out of the angled drive-through slot, the vehicle transitioning from the angled drive-through slot to the egress lane via a second obtusely angled turn, the first and second obtuse angles of the turns having substantially similar degree values. In another aspect, the lane system further comprises two intermediary lanes, each intermediary lane directly connecting the entrance and egress lanes to each other, the angled drive-through slots positioned between the intermediary lanes. In yet another embodiment of the electronic drive-through delivery system, a point-of-sale (POS) system is communicatively connected to the central server.

In another embodiment, a drive-through delivery system comprises a plurality of

electronic kiosks configured to receive customer orders; a central order-processing server that is communicatively connected to the plurality of electronic kiosks; a plurality of angled drive-through slots, the angled drive-through slots receiving customers in their vehicles and configured to receive ordered items; an entrance lane; an egress lane, the drive-through slots being angled relative to the entrance and egress lanes; a canopy structure, the angled drive-through slots covered by the canopy structure; and a plurality of standard parking spaces. In one aspect, the lanes are one-way, wherein the plurality of electronic kiosks are positioned at the angled drive-through slots, the angled drive-through slots being positioned between the entrance and egress lanes, the egress lane being accessible from the entrance lane through the angled drive-through slots, and wherein the plurality of standard parking spaces lie adjacent to the entrance lane, the entrance lane being positioned between the angled drive-through slots and the standard parking spaces. In another aspect, at least three customers can order and pay simultaneously.

In another aspect, each angled drive-through slot corresponds with one electronic kiosk, each electronic kiosk comprising a screen and a processing unit, each processing unit running a client-side order-processing application configured to visually output an interface onto the screen of its kiosk, wherein the central order-processing server runs a server-side order-processing application configured to receive customer orders placed via the kiosk interface, the server-side order-processing application further configured to process the orders for preparation and delivery of ordered items. In yet another aspect, the vehicle transitions from the entrance lane to an angled drive-through slot via a first obtusely angled turn, the customer having a line-of-sight to the entire egress lane when pulling out of the angled drive-through slot, the vehicle transitioning from the angled drive-through slot to the egress lane via a second obtusely angled turn, the first and second obtuse angles of the turns having substantially similar degree values. In a further aspect, the delivery system further comprises two intermediary lanes, each intermediary lane directly connecting the entrance and egress lanes to each other, the angled drive-through slots positioned between the intermediary lanes. In another aspect, a point-of-sale (POS) system is communicatively connected to the central order-processing server.

In another embodiment, a method for using an electronic drive-through delivery system, the system serving a customer in a vehicle, comprises entering a restaurant's land parcel using an entrance lane; pulling into a drive-through slot that is angled relative to the entrance lane, a plurality of such drive-through slots being disposed adjacent to the entrance lane; placing an order using a kiosk while parked in the drive-through slot, the kiosk having a screen with menu items that are orderable via an interface provided by a client-side application running on the kiosk; paying for the order using the kiosk; processing the order using a server-side application running on a central server that is communicatively connected to the kiosk; preparing the order; delivering the order to the customer parked in the drive-through slot, the order delivered by a runner; and exiting the restaurant's land parcel by pulling into an egress lane positioned adjacent to the drive-through slots, the drive-through slots being angled further relative to the egress lane. In one aspect, at least three customers can order and pay simultaneously, the delivery system being configured to minimize a backup queue of customers and to eliminate a bottleneck of exiting customers. In another aspect, the angled drive-through slots are covered by a canopy structure. In a further aspect, the lanes and slots are one-way, and wherein the vehicle transitions from the entrance lane into an angled drive-through slot via a first obtusely angled turn, the customer having a line-of-sight to the entire egress lane when pulling out of the angled drive-through slot, the vehicle transitioning from the angled drive-through slot to the egress lane via a second obtusely angled turn, the first and second obtuse angles of the turns having substantially similar degree values.

### BRIEF DESCRIPTION OF THE DRAWINGS

FIG. 1 illustrates an overhead schematic view of a land parcel having an angled or rhomboid one-way lane system with integrated angled drive-through slots in accordance with an embodiment of the present disclosure.

FIG. 2 illustrates an overhead schematic view of a land parcel having a curved one-way lane system with integrated angled drive-through slots in accordance with an embodiment of the present disclosure.

FIG. 3 illustrates a top perspective view of a plurality of angled drive-through slots with electronic kiosks covered by a canopy structure in accordance with an embodiment of the present disclosure.

FIG. 4 illustrates a high-level diagram of an electronic ordering system in accordance with an embodiment of the present disclosure.

FIG. 5 illustrates a flowchart outlining a method for using an angled drive-through delivery system in accordance with an embodiment of the present disclosure.

### DETAILED DESCRIPTION

In the following discussion, numerous specific details are set forth to provide a thorough understanding of the disclosed subject matter. However, those skilled in the art will appreciate that the present disclosed subject matter may be practiced without such specific details. In other instances, well-known elements, processes or techniques have been briefly mentioned and not elaborated on in order not to obscure the disclosed subject matter in unnecessary detail and description. Moreover, specific details and the like may have been omitted inasmuch as such details are not deemed necessary to obtain a complete understanding of the disclosed subject matter, and are considered to be within the understanding of persons having ordinary skill in the relevant art.

Embodiments of the present invention include an angled drive-through delivery system, along with a method for using this delivery system. The angled drive-through delivery system is designed to provide a faster, more efficient way to process customer orders and increase fill rate by deployment of a semi-automated system into a lane system having an angled drive-through design that optimizes drive-through vehicle flow and maximizes spatial utility within a parcel of land having a limited size. In some embodiments, the angled drive-through delivery system comprises a plurality of electronic kiosks positioned along a plurality of corresponding angled drive-through slots and communicatively connected to a central order-processing server. In some embodiments, the angled drive-through delivery system further comprises a client-side kiosk application that runs on a kiosk processing unit embedded in each kiosk, as well as a server-side order-processing application that runs on the central order-processing server. In some embodiments, the client-side kiosk application is configured to visually output a kiosk interface onto a screen of the kiosk when the client-side kiosk application is running on a processing unit of the kiosk. Each electronic kiosk is positioned adjacent to a corresponding angled drive-through slot, the kiosk being positioned such that a vehicle is parked sufficiently within the angled drive-through slot so as not to block other vehicles from entering other angled drive-through slots. Kiosk orders can be placed by drivers, or customers, of the parked vehicles, with server-side processing of the orders in real-time, and with runners delivering the orders to the customers. After delivery of an order to a customer, the driver of the vehicle pulls forward out of the angled drive-through slot to an egress location, or lane, and out to the common roadway. In this way, the angled drive-through delivery system results in smaller queue back-ups and less delays for the customers placing the orders.

As stated above, normal drive-through organization and ordering systems typically involve one-at-a-time ordering and delivery. Consequently, this often leaves customers waiting in a queue behind the window and slows down both ordering and delivery. This complication can persist regardless of how much onsite or available land can be acquired. Embodiments of the angled drive-through delivery system and usage method described in this disclosure solve such problems by implementing a lane system, parking design, and semi-automated ordering system that together enable more cars to place orders simultaneously. This results in less cars stuck in a queue, less backup, and less delay, as the present invention's design ensures that multiple kiosks are available to multiple customers for ordering, allowing for a sufficient flow of vehicles driven by those customers without backup or delay, as in conventional drive-through queues. Furthermore, the ordered food is delivered in a timelier and more efficient manner compared to conventional drive-through queues.

Embodiments of the angled drive-through delivery system and method of usage described in this specification differ from and improve upon currently existing options. In particular, some embodiments differ by using a drive-in/drive-through design with multiple kiosks, which allows faster ordering and less wait time than a single window with a backed-up queue. The parkable, angled drive-through slots positioned between an entrance and egress lane are what promote a uniquely flowing stream of lot traffic. Additionally, the angled drive-through delivery system is a semi-automated system that provides user interaction at kiosks and communication to a backend server with an order-processing application running. Furthermore, customers have line of sight when pulling out of the angled parking slots, to further relieve bottle-necking. This is a vast improvement over conventional drive-through systems which commonly have long delays, huge, backed-up vehicle queues, and are generally too slow for most customers. Consequently, many customers tend to get frustrated and leave. In contrast, the angled drive-through delivery system provides an optimized design that allows customers to make more orders and, by the backend server processing, the efficient, real-time handling of more orders than could otherwise be placed via existing conventional drive-through systems. Runners deliver orders to the customers and help the process of pulling out one at a time. In some embodiments, the present semi-automated system is designed to deliver orders in closed containers through underground or above-ground conveyor belts.

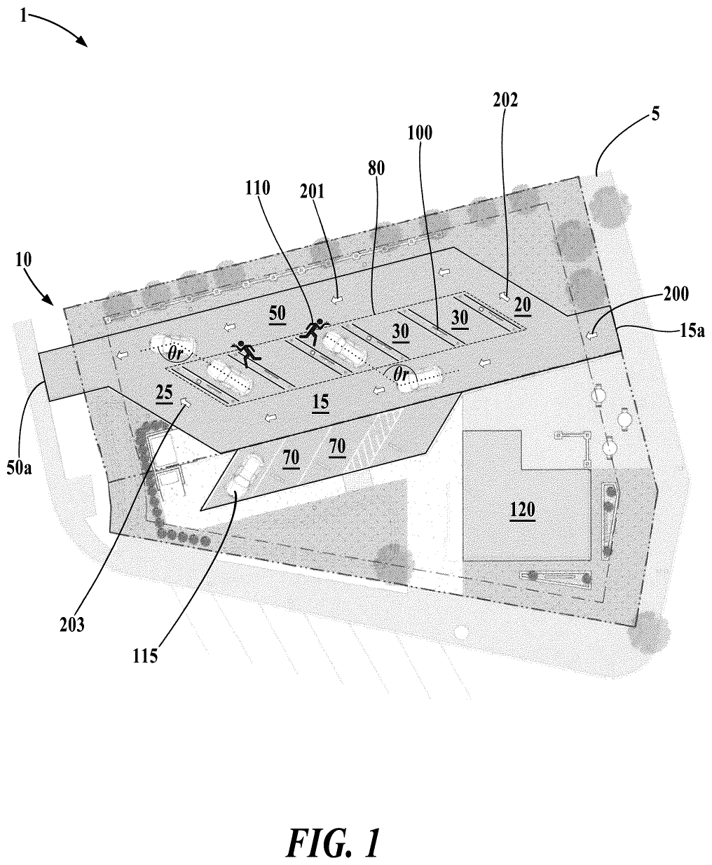

Referring to FIG. 1, an overhead schematic view of a land parcel 5 shows a generally angled or rhomboid one-way lane system 10 with integrated angled drive-through slots 30. An electronic drive-through delivery system 1 operates within a land parcel 5, the land parcel having a restaurant 120, to serve customers in vehicles 115. The delivery system 1 comprises the lane system 10 established in the land parcel 5 and designed to minimize a backup queue of customers, while eliminating a bottleneck of exiting customers. The lane system 10 comprises a plurality of angled drive-through slots 30 at which a plurality of electronic kiosks 100 are positioned, each slot corresponding with one kiosk, the slots receiving customers in their vehicles 115. The lane system 10 further comprises an entrance lane 15 having an entrance point 15a, along with an egress lane 50 having an exit point 50a. The entrance lane 15 and egress lane 50 may be referred to as the main lanes in the lane system 10. The egress lane 50 is vehicle-accessible from the entrance lane 15 through the angled drive-through slots 30, the drive-through slots being angled relative to the entrance lane 15 and egress lane 50. In the depicted exemplary embodiment, the lane system 10 having an overall rhomboid shape, the entrance lane 15 and egress lane 50 run substantially parallel to each other, the angled drive-through slots 30 being linearly positioned in series between the entrance and egress lanes. Exemplary lanes are one-way, likewise with the drive-through slots 30, which receive only one-way traffic from the entrance lane 15 to the egress lane 50.

Regarding vehicle navigation through the lane system 10, a vehicle 115, having entered an establishment's lot 5 and crossing the entrance point 15a, progresses along the entrance lane 15 as indicated by motion arrows 200. The vehicle 115 transitions from the entrance lane 15 to an angled drive-through slot 30 via a first obtusely angled turn, the customer having a line-of-sight to the entire egress lane 50 when pulling out of the angled drive-through slot 30. The vehicle 115 transitions from the angled drive-through slot 30 to the egress lane 50 via a second obtusely angled turn, the first and second obtuse angles θr (the rays shown with dotted lines) of the turns having substantially similar degree values. The vehicle 115 progresses along the egress lane 50 as indicated by motion arrows 201, finally crossing the exit point 50a and leaving the lot 5.

In some embodiments, the delivery system 1 further comprises two intermediary lanes, including a first intermediary lane 20 and a second intermediary lane 25. Each intermediary lane directly connects the entrance lane 15 with the egress lane 50, allowing vehicles 115 to bypass the drive-through slots 30 by driving directly from entrance lane to egress lane, if necessary. As a group, the linearly disposed angled drive-through slots 30 have a perimeter, this perimeter generally defined by the dashed outline of the canopy structure 80 and having a four-sided rhomboid shape with length sides and width sides. The drive-through slots 30 are positioned between the intermediary lanes and main lanes such that each intermediary lane runs parallel and adjacent to a width side of the above-mentioned rhombus, while each main lane runs parallel and adjacent to a length side of the same rhombus. Like all other exemplary lanes in the lane system 10, the intermediary lanes also receive only one-way traffic. Motion arrow 202 indicates progression of a vehicle 115 along the first intermediary lane 20 between the main lanes. Motion arrow 203 indicates progression of a vehicle 115 along the second intermediary lane 25 between the main lanes.

In some examples, the land parcel 5 includes a plurality of standard parking spaces 70 positioned adjacent to the entrance lane 15, the entrance lane positioned between the angled drive-through slots 30 and the standard parking spaces. The standard parking spaces 70, which may be obliquely angled or orthogonally positioned relative to the entrance lane 15, provide an overflow area in case a backup queue of customers does begin to form in the lot 5 and lane system 10. Ordered items are prepared in the restaurant facility then delivered by runners 110 to the customers parked in the angled drive-through slots 30. The exemplary plurality of angled drive-through slots 30 are covered by an overhead canopy structure 80 (shown in FIG. 1 with dashed lines so as not to obscure the covered slots below it). In an exemplary angled drive-through delivery system 1, at least two customers can order and pay simultaneously using the electronic kiosks 100 while parked in the drive-through slots 30. There is no upper limit to how many customers can be served using the present delivery system 1, which includes a substantially self-serve ordering system.

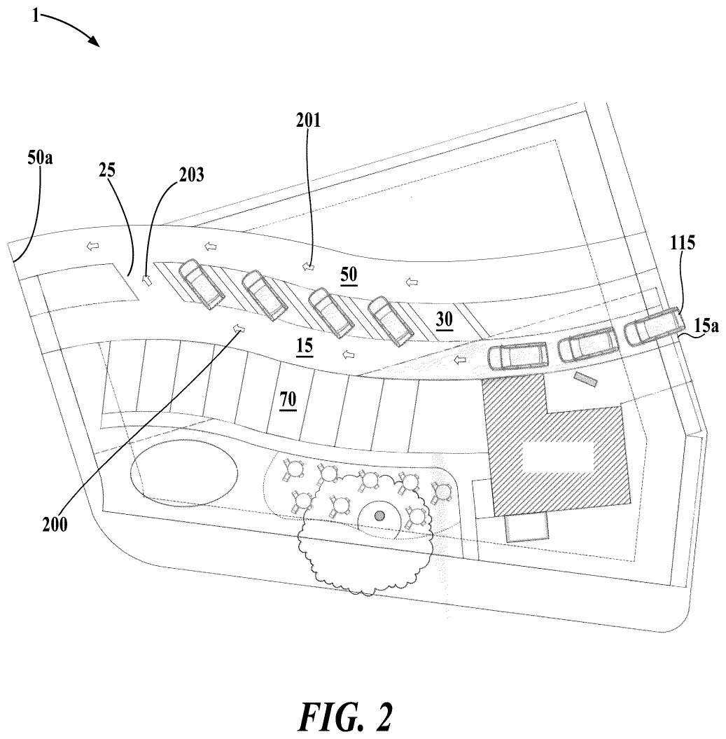

Referring to FIG. 2, an overhead schematic view shows a land parcel 5 with drive-through delivery system 1 having a curved one-way lane system 10 with integrated angled drive-through slots 30, most of which are occupied by a parked vehicle 115. The one-way entrance lane 15, with entrance point 15a, has at least one curve whereby a vehicle 115 slightly changes its orientation (by less than 90 degrees) as it progresses along the lane 15, as indicated by motion arrows 200. The drive-through slots 30 lie adjacent to the curving entrance lane 15, extending from it at an angle, as in the previously depicted example, the series of slots 30 following any curves of the entrance lane 15. A one-way second intermediary lane 25 again provides an angled transition from the entrance lane 15 to the egress lane 50, motion arrow 203 indicating progression of a vehicle 115 through the second intermediary lane and toward the egress lane 50. The drive-through slots 30 are angled relative to the egress lane 50 as well, the egress lane running adjacently to the angled drive-through slots and having substantially the same path and curvature as the entrance lane, the slots 30 also following any curves of the egress lane 50. A vehicle 115 pulls out of an angled drive-through slot 30 directly onto the one-way egress lane 50, progressing toward an exit point 50a as indicated by motion arrows 201, the vehicle slightly changing its orientation (by less than 90 degrees) as it progresses. Although not depicted in FIG. 2, a one-way first intermediary lane 20 may also be included in the lot configuration shown, this lane 20 lying nearer to the entrance point 15a. A series of standard parking spaces 70 extend from the entrance lane 15 in a direction opposite that of the drive-through slots 30 from the lane 15. The standard parking spaces 70 similarly follow the curvature of the entrance lane 15.

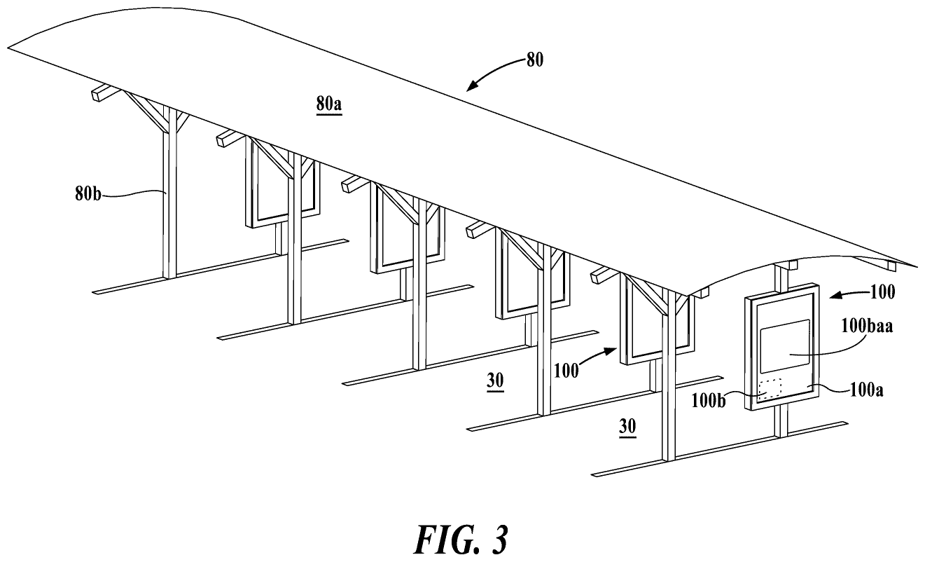

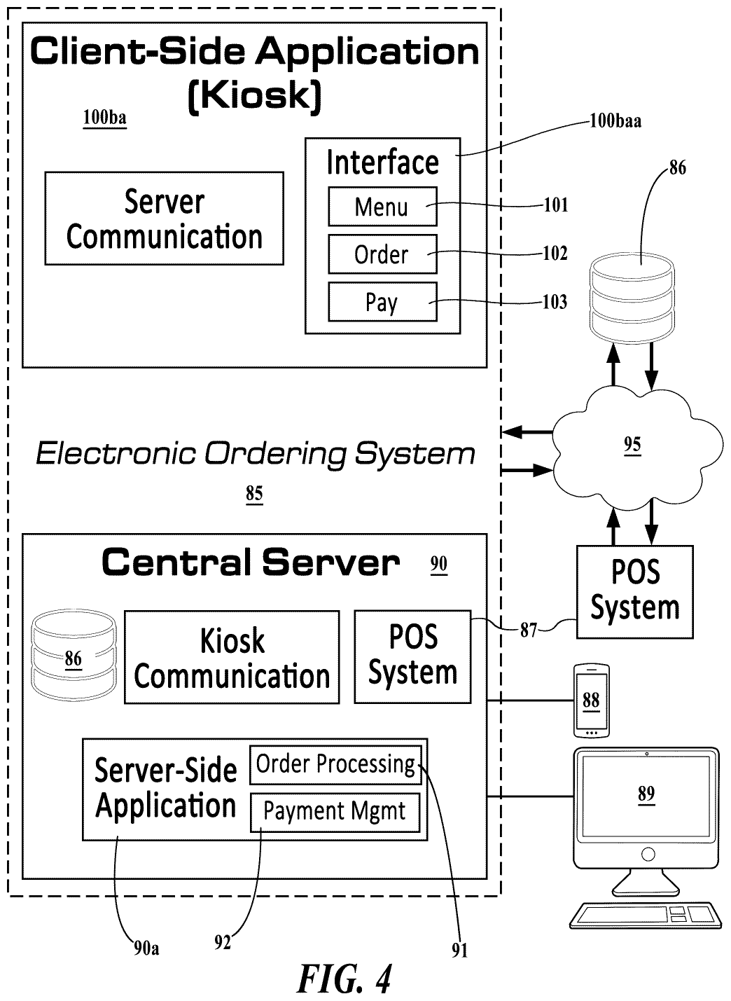

Referring to FIG. 3, a top perspective view shows a plurality of angled drive-through slots 30 with electronic kiosks 100 covered by a canopy structure 80. Each of the plurality of electronic kiosks 100 comprises a screen 100a and a processing unit 100b (shown with dashed lines as it lies within the kiosk), each processing unit running an application (see client-side application 100ba of FIG. 4) that visually outputs an interface 100baa onto the screen of its kiosk. A customer can touch and speak to the screen 100a and interact with the interface 100baa in various ways to initiate and complete the ordering process. The kiosks 100 are positioned nearer to the egress lane 50 than the entrance lane 15 to better accommodate a driver. The canopy structure 80 comprises an overhang 80a and vertical structural supports 80b, the structural supports rising from the ground to meet the overhang via other connective structural supports. The overhang 80a can be angled with a ridge, or curved as shown, and covers the entire series of angled drive-through slots 30 for weather protection.

Referring to FIG. 4, a high level diagram shows aspects of an electronic ordering system 85 of an angled drive-through delivery system 1. The electronic ordering system 85 receives and processes customer orders, and comprises the above-mentioned client-side application 100ba running on each kiosk 100, as well as a central order-processing server 90. The client-side application 100ba comprises the interface 100baa which includes a menu 101 with food options, an order function 102, and a pay function 103. The central server 90 is communicatively connected to the plurality of electronic kiosks 100 and associated client-side application 100ba, the server running a server-side order-processing application 90a that receives customer orders placed via the kiosk interface 100baa. Using an order-processing function 91, the server-side order-processing application 90a further processes the orders for preparation and delivery of ordered items by the runners 110 to customers parked in their vehicles 115 in the drive-through slots 30. The server-side order-processing application 90a further comprises a payment management function 92 to process customer payments made at the kiosks 100. In some embodiments, a point-of-sale (POS) system 87 is integrated into, or externally connected to, the central server 90. Information (data) is stored in a database 86 that is connected directly to the central server 90 or to a cloud database 86 via the cloud 95. The central server 90 can be accessed directly using a desktop computing device 89 or a mobile computing device 88.

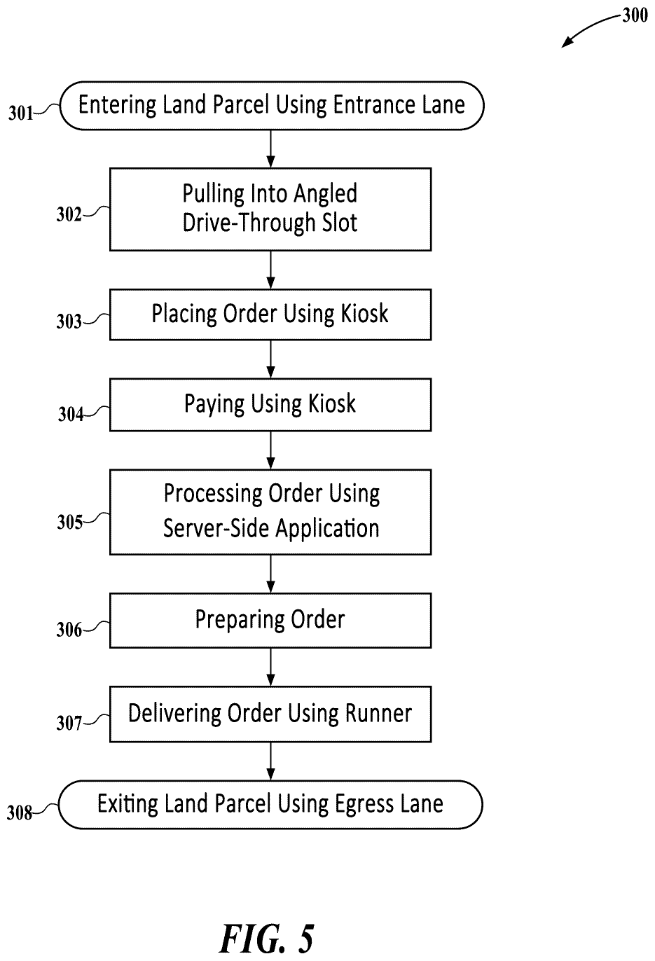

Referring to FIG. 5, a flowchart outlines a method 300 for using an angled drive-through delivery system 1. To use the angled drive-through delivery system 1, a customer begins by driving their vehicle into a land parcel 5 through the entrance point 15a of the entrance lane 15, as indicated by step 301. As indicated by step 302, the customer continues by pulling into a drive-through slot 30 that is angled relative to the entrance lane 15, a plurality of such drive-through slots being disposed adjacent to the entrance lane. Continuing with step 303, the customer then places an order using a kiosk 100 while parked in the drive-through slot 30, the kiosk 100 having a screen 100a with menu items that are orderable via an interface 100baa provided by a client-side application 100ba running on the kiosk. As step 304 shows, the customer then pays for the order using the kiosk 100. In step 305, the order is processed using a server-side application 90a running on a central server 90 that is communicatively connected to the customer's kiosk 100. The order is then prepared within a restaurant facility 120, as indicated by step 306. The order is then delivered to the customer parked in the drive-through slot 30, the order delivered by a runner 110 who speedily transports the order from within the restaurant 120 to the customer, as indicated by step 307. Finally, as shown with step 308, the customer exits the restaurant's land parcel 5 by pulling into an egress lane 50 positioned adjacent to the drive-through slots 30, the drive-through slots being angled further relative to the egress lane, the egress lane having an exit point 50a via which the customer may exit the egress lane and land parcel 5. The present invention allows customer ordering, payment, and delivery to multiple vehicles at a time instead of using a single or even double window drive-through. By following the steps above, multiple customers can safely and efficiently order at the same time, pay for their respective orders, and receive their orders in a timely manner. The angled slot design implemented at any given restaurant is based on the standards and local laws of its jurisdiction (e.g., the standards and local laws of California). Typically, there are at least two drive-through slots 30, each having a kiosk 100. However, there is no upper limit on the number of angled drive-through slots 30 and corresponding kiosks 100. The angled slots 30 or ports allow all drivers to clearly visualize their surroundings while exiting the slots to enter the egress lane 50.

Many variations may be made to the embodiments described herein. All variations are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

There may be many other ways to implement the disclosed embodiments. Various functions and elements described herein may be partitioned differently from those shown without departing from the scope of the disclosed embodiments. Various modifications to these implementations may be readily apparent to those skilled in the art, and generic principles defined herein may be applied to other implementations. Thus, many changes and modifications may be made to the disclosed embodiments, by one having ordinary skill in the art, without departing from the scope of the disclosed embodiments. For instance, different numbers of a given element or module may be employed, a different type or types of a given element or module may be employed, a given element or module may be added, or a given element or module may be omitted.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

1. An electronic drive-through delivery system operating within a restaurant's land parcel to serve customers in vehicles, the system comprising:
(a.) an electronic ordering system configured to receive and process customer orders, the electronic ordering system comprising:
(i.) a plurality of electronic kiosks, each electronic kiosk comprising a screen and a processing unit, each processing unit running a client-side application configured to visually output an interface onto the screen of its kiosk;
(ii.) a central server that is communicatively connected to the plurality of electronic kiosks, the server running a server-side order-processing application configured to receive customer orders placed via the kiosk interface, the server-side order-processing application further configured to process the orders for preparation and delivery of ordered items;
(b.) a lane system established in the land parcel and configured to minimize a backup queue of customers and to eliminate a bottleneck of exiting customers, the lane system comprising:
(i.) a plurality of angled drive-through slots at which the plurality of electronic kiosks are positioned, each slot corresponding with one kiosk, the slots receiving customers in their vehicles;
(ii.) an entrance lane;
(iii.) an egress lane, the egress lane being accessible from the entrance lane via the angled drive-through slots, the drive-through slots being angled relative to the entrance and egress lanes; and,
wherein the ordered items are delivered by runners to the customers parked in the angled drive-through slots.

2. The electronic drive-through delivery system of claim 1, wherein the entrance and egress lanes run substantially parallel to each other, the angled drive-through slots being positioned between the entrance and egress lanes.

3. The electronic drive-through delivery system of claim 2, wherein the lane system includes only one-way lanes.

4. The electronic drive-through delivery system of claim 3, wherein at least three customers can order and pay simultaneously.

5. The electronic drive-through delivery system of claim 4, wherein the angled drive-through slots are covered by a canopy structure.

6. The electronic drive-through delivery system of claim 5, wherein the land parcel includes a plurality of standard parking spaces positioned adjacent to the entrance lane, the entrance lane positioned between the angled drive-through slots and the standard parking spaces.

7. The electronic drive-through delivery system of claim 6, wherein the vehicle transitions from the entrance lane to an angled drive-through slot via a first obtusely angled turn, the customer having a line-of-sight to the entire egress lane when pulling out of the angled drive-through slot, the vehicle transitioning from the angled drive-through slot to the egress lane via a second obtusely angled turn, the first and second obtuse angles of the turns having substantially similar degree values.

8. The electronic drive-through delivery system of claim 7, wherein the lane system further comprises two intermediary lanes, each intermediary lane directly connecting the entrance and egress lanes to each other, the angled drive-through slots positioned between the intermediary lanes.

9. The electronic drive-through delivery system of claim 8, wherein a point-of-sale (POS) system is communicatively connected to the central server.

10. A drive-through delivery system comprising:
(a.) a plurality of electronic kiosks configured to receive customer orders;
(b.) a central order-processing server that is communicatively connected to the plurality of electronic kiosks;
(c.) a plurality of angled drive-through slots, the angled drive-through slots receiving customers in their vehicles and configured to receive ordered items;
(d.) an entrance lane;
(e.) an egress lane, the drive-through slots being angled relative to the entrance and egress lanes;
(f.) a canopy structure, the angled drive-through slots covered by the canopy structure; and
(g.) a plurality of standard parking spaces.

11. The delivery system of claim 10, wherein the lanes are one-way, wherein the plurality of electronic kiosks are positioned at the angled drive-through slots, the angled drive-through slots being positioned between the entrance and egress lanes, the egress lane being accessible from the entrance lane through the angled drive-through slots, and wherein the plurality of standard parking spaces lie adjacent to the entrance lane, the entrance lane being positioned between the angled drive-through slots and the standard parking spaces.

12. The delivery system of claim 11, wherein at least three customers can order and pay simultaneously.

13. The delivery system of claim 12, wherein each angled drive-through slot corresponds with one electronic kiosk, each electronic kiosk comprising a screen and a processing unit, each processing unit running a client-side order-processing application configured to visually output an interface onto the screen of its kiosk, wherein the central order-processing server runs a server-side order-processing application configured to receive customer orders placed via the kiosk interface, the server-side order-processing application further configured to process the orders for preparation and delivery of ordered items.

14. The delivery system of claim 13, wherein the vehicle transitions from the entrance lane to an angled drive-through slot via a first obtusely angled turn, the customer having a line-of-sight to the entire egress lane when pulling out of the angled drive-through slot, the vehicle transitioning from the angled drive-through slot to the egress lane via a second obtusely angled turn, the first and second obtuse angles of the turns having substantially similar degree values.

15. The delivery system of claim 14, wherein the delivery system further comprises two intermediary lanes, each intermediary lane directly connecting the entrance and egress lanes to each other, the angled drive-through slots positioned between the intermediary lanes.

16. The delivery system of claim 15, wherein a point-of-sale (POS) system is communicatively connected to the central order-processing server.

17. A method for using an electronic drive-through delivery system, the system serving a customer in a vehicle, the method comprising:
(a.) Entering a restaurant's land parcel using an entrance lane;
(b.) Pulling into a drive-through slot that is angled relative to the entrance lane, a plurality of such drive-through slots being disposed adjacent to the entrance lane;
(c.) Placing an order using a kiosk while parked in the drive-through slot, the kiosk having a screen with menu items that are orderable via an interface provided by a client-side application running on the kiosk;
(d.) Paying for the order using the kiosk;
(e.) Processing the order using a server-side application running on a central server that is communicatively connected to the kiosk;
(f.) Preparing the order;
(g.) Delivering the order to the customer parked in the drive-through slot, the order delivered by a runner; and,
(h.) Exiting the restaurant's land parcel by pulling into an egress lane positioned adjacent to the drive-through slots, the drive-through slots being angled further relative to the egress lane.

18. The method of claim 17, wherein at least three customers can order and pay simultaneously, the delivery system being configured to minimize a backup queue of customers and to eliminate a bottleneck of exiting customers.

19. The method of claim 18, wherein the angled drive-through slots are covered by a canopy structure.

20. The method of claim 19, wherein the lanes and slots are one-way, and wherein the vehicle transitions from the entrance lane into an angled drive-through slot via a first obtusely angled turn, the customer having a line-of-sight to the entire egress lane when pulling out of the angled drive-through slot, the vehicle transitioning from the angled drive-through slot to the egress lane via a second obtusely angled turn, the first and second obtuse angles of the turns having substantially similar degree values.
